(19) United States
(12) Patent Application Publication
(10) Pub. No.: US 2015/0156776 A1
(43) Pub. Date: Jun. 4, 2015

(54) METHOD OF BANDWIDTH CONFIGURATION FOR A USER EQUIPMENT IN A MTC BASED COMMUNICATION NETWORK

(71) Applicant: Alcatel Lucent, Boulogne Billancourt (FR)

(72) Inventors: Yu Chen, Shanghai (CN); Sigen Ye, Whitehouse Station, NJ (US)

(73) Assignee: ALCATEL LUCENT, Boulogne Billancourt (FR)

(21) Appl. No.: 14/412,720

(22) PCT Filed: Jun. 10, 2013
(86) PCT No.: PCT/IB2013/001511

§ 371 Date: Jan. 5, 2015

(30) Foreign Application Priority Data
Jul. 5, 2012 (CN) 201210232189.8

(51) Int. Cl. H04W 72/04; H04W 4/00

(52) U.S. Cl. CPC H04W 72/0453; H04W 4/005

(57) ABSTRACT

The present invention relates to a method, in a base station of a MTC based communication system, of configuring bandwidth for a MTC user equipment, wherein bandwidth of the MTC user equipment is smaller than system bandwidth for MTC, the method comprising the steps of: receiving a first message from the MTC user equipment, the first message indicating an offset of bandwidth selected by the MTC user equipment according to a predetermined selection policy relative to the system bandwidth, wherein the selected bandwidth covers center frequency band of the system bandwidth; determining the bandwidth selected by the MTC user equipment according to the first message. According to the invention, the system bandwidth for MTC and the bandwidth of the MTC user equipments can be asymmetrically increased, while extending the capacity of MTC by allocating wider bandwidth. The cost for the user equipments in a MTC based communication system could be saved by reserving the bandwidth of the MTC user equipments or by reducing the increment of the bandwidth of the MTC user equipments while increasing the system bandwidth for MTC.

### FIELD OF THE INVENTION

The present invention relates to a Machine Type Communication based communication system, and particularly to a method of and an apparatus for bandwidth configuration for a Machine Type Communication user equipment in a Machine Type Communication based communication system.

### BACKGROUND OF THE INVENTION

Machine Type Communication (MTC) is a new item introduced in the Long Term Evolution system. The MTC user equipments are quite probable to be those meter like devices (e.g. ammeter etc.) which run simple is applications and generate small amount of packets each time. Although each packet generated by the MTC user equipments may be quite small, many signaling interactions are needed to upload these small packets. Consequently, Machine Type Communication occupies a certain amount of bandwidth.

With the development of MTC, the number of MTC user equipments in a MTC based communication system increases consistently, thus it is difficult for the bandwidth of 1.08 MHz allocated for MTC according to the current standard to satisfy the deployment in the future. 3 MHz or 5 MHz bandwidth might be more suitable, where MTC has a higher capacity and a better performance could be achieved through frequency diversity.

The bandwidth requirement of MTC could be satisfied by increasing the system bandwidth for MTC while symmetrically increasing the bandwidth of the MTC user equipments. However, since the RF unit takes about 40% of the total cost of a MTC user equipment, the cost of the MTC user equipment would be highly increased, if the bandwidth of the MTC user equipment is increased.

### SUMMARY OF THE INVENTION

Based on the above consideration, it is very advantageous to propose a method of bandwidth configuration enabling asymmetric increase of the system bandwidth for MTC and the bandwidth of the MTC user equipments.

According to a first aspect of the invention, there is provided a method, in a base station of a Machine Type Communication based communication system, of configuring bandwidth for a Machine Type Communication user equipment. Wherein bandwidth of the Machine Type Communication user equipment is smaller than system bandwidth for Machine Type Communication, the method comprising the steps of: receiving a first message from the Machine Type Communication user equipment, the first message indicating an offset of bandwidth selected by the Machine Type Communication user equipment according to a predetermined selection policy relative to the system bandwidth, wherein the selected bandwidth covers the center frequency band of the system bandwidth; determining the bandwidth selected by the Machine Type Communication user equipment according to the first message.

In an embodiment of the invention, before the step of receiving a first message from the Machine Type Communication user equipment, the method further comprises a step of sending a second message to the Machine Type Communication user equipment, the second message indicating a size of the system bandwidth for Machine Type Communication. Alternatively, the method further comprises a step of sending a third message to the Machine Type Communication user equipment, the third message indicating the predetermined selection policy.

In an embodiment of the invention, the predetermined selection policy comprises any one or any combination of: selecting randomly, selecting according to a probability distribution, selecting according to a type of the Machine Type Communication user equipment.

According to a second aspect of the invention, there is provided a method, in a Machine Type Communication user equipment of a Machine Type Communication based communication system, of assisting in configuring bandwidth. Wherein, bandwidth of the Machine Type Communication user equipment is smaller than system bandwidth for Machine Type Communication, the method comprising the steps of: selecting bandwidth for the Machine Type Communication user equipment according to a predetermined selection policy, while ensuring that the selected bandwidth covers center frequency band of the system bandwidth; sending a first message to a base station, the first message indicating an offset of the selected bandwidth relative to the system bandwidth.

According to a third aspect of the invention, there is provided an apparatus, in a base station of a Machine Type Communication based communication system , of configuring bandwidth for a Machine Type Communication user equipment, wherein bandwidth of the Machine Type Communication user equipment is smaller than system bandwidth for Machine Type Communication, the apparatus comprising: a first receiving device, for receiving a first message from the Machine Type Communication user equipment, the first message indicating an offset of bandwidth selected by the Machine Type Communication user equipment according to a predetermined selection policy relative to the system bandwidth, wherein the selected bandwidth covers center frequency band of the system bandwidth; a determining device, for determining the bandwidth selected by the Machine Type Communication user equipment according to the first message.

According to a fourth aspect of the invention, there is provided an apparatus, in a Machine Type Communication user equipment of a Machine Type Communication based communication system, for assisting in configuring bandwidth, wherein bandwidth of the Machine Type Communication user equipment is smaller than system bandwidth for Machine Type Communication, the apparatus comprising: a selecting device, for selecting bandwidth for the Machine Type Communication user equipment according to a predetermined selection policy, while ensuring that the selected bandwidth covers center frequency band of the system bandwidth; a second sending device, for sending a first message to a base station, the first message indicating an offset of the selected bandwidth relative to the system bandwidth.

According to the present invention, MTC user equipments can select an offset before access. This offset can be selected randomly by the user equipment itself, or can be selected according to a probability distribution, or can be selected according to a type of the MTC user equipment. All the bandwidth selected by the user equipments at least overlaps at the center frequency band, i.e. 6 RBs to receive the critical system information. The frequency offset is reported to the base station during access. The benefit is obvious that the system bandwidth for MTC and the bandwidth of the MTC user equipments can be asymmetrically increased, while extending the capacity of MTC by allocating wider bandwidth. The cost for the user equipments in a MTC based communication system could be saved by reserving the bandwidth of the MTC user equipments or by reducing the increment of the bandwidth of the MTC user equipments while increasing the system bandwidth for MTC.

The MTC bandwidth is extended by 60% for 3 MHz bandwidth and 76% for 1.4 MHz. Further considering the DC issue, the base station in a MTC based communication system may use wider RF bandwidth, while the MTC user equipments may use narrow baseband bandwidth or reserve the center downlink subcarriers of the MTC user equipments.

Various aspects of this invention will become apparent from the following detailed description of the embodiments.

### BRIEF DESCRIPTION OF DRAWINGS

Other features, objects and advantages of the invention will become more apparent from the following detailed description of non-limiting embodiments with reference to the drawings. In the drawings:

FIG. 1 illustrates a schematic view of the message transmission between the MTC user equipment and the base station according to the prior art;

FIG. 2 illustrates a flow chart of the method according to an embodiment of the invention;

FIG. 3 illustrates the relationship between the bandwidth selected by the MTC user equipments and the system bandwidth according to an embodiment of the invention;

FIG. 4 illustrates a block diagram of an apparatus in a base station, for configuring bandwidth for a MTC user equipment according to an embodiment of the invention;

FIG. 5 illustrates a block diagram of an apparatus in a MTC user equipment, for assisting in configuring bandwidth according to an embodiment of the invention.

### DETAILED DESCRIPTION OF EMBODIMENTS

In the following detailed description of the preferred embodiments, reference will be made to the appended drawings composing a part of the invention. The appended drawings illustrate specific embodiments implementing the invention in an exemplary manner. The exemplary embodiments are not intended to exhaust all the embodiments of the invention. It should be appreciated that other embodiments could be used, or structural or logical modification could be made with out departing from the scope of the invention. Thus the detailed description below is not constrictive, the scope of the invention is defined in the appended claims.

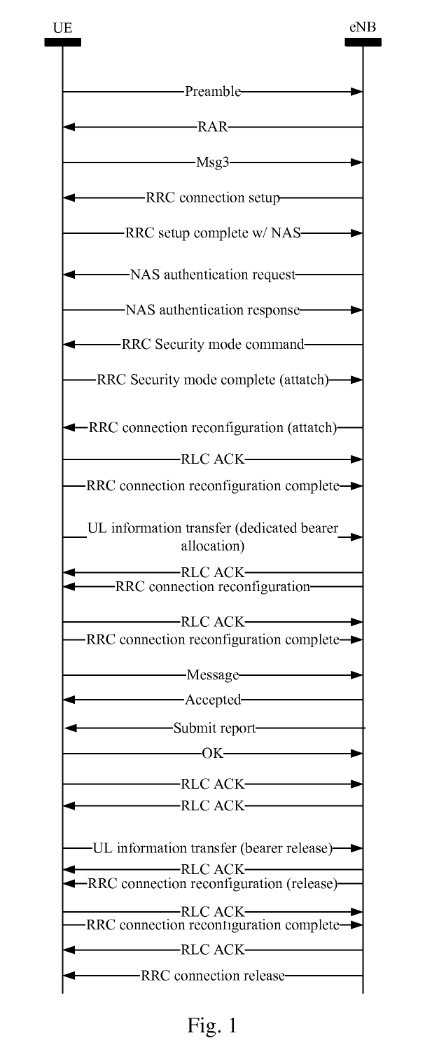

FIG. 1 illustrates a schematic view of the message transmission between the MTC user equipment MTC UE and the base station eNB according to the prior art. As illustrated, the process is the procedure starting from the user equipment accesses the network until that the Radio Resource Control(RRC) connection is released.

As for one aspect, although each packet generated by the MTC user equipments may be quite small, many signaling interactions are needed to upload these small packets, as can be seen from the complete SMS based data uploading procedure illustrated in FIG. 1.

As for another aspect, the transmission of signaling and data in this procedure need scheduling by Physical Downlink Control Channel (PDCCH), and this further generates the PDCCH load. As stated, the major part of the traffic is signaling, and the downlink transmission and uplink transmission are very symmetric and would generate similar amount of upper layer signaling and data load. If the PDCCH is taken into account, the downlink load may be around two times uplink load. It is quite probable that the capacity bottleneck exists in downlink or both downlink and uplink. Then, it is necessary to consider the downlink capacity when considering the needed maximum bandwidth.

In the following, the capacity of the MTC based communication system is analyzed for different bandwidth in detail.

Specifically, to keep the backward compatibility, it is preferable to design the ePDCCH of MTC as a Physical Layer signaling channel, PDCCH. Consequently, a part of the data region for PDSCH is used for PDCCH, and this impacts the capacity of data. Next, in the following analysis the ePDCCH is assumed to be multiplexed with PDSCH, and the granularity of the multiplexing is one Physical Resource Block (PRB) pair. Considering there are only 6 RBs for a 1.08 MHz bandwidth, the resources are quite limited and hard to satisfy the deployment in the future.

The RRC message size varies for different OPTIONAL fields. Here are some examples of downlink RRC message size encapsulated in DL-DCCH or DL-CCCH. For 1.5 bps/Hz spectrum efficiency, one PRB pair has the capacity of 540 bits approximately. Hence, each transmission only needs one or two PRB pair normally.

TABLE 1
downlink RRC message size

| Messages | Message size (bits) |
|---|---|
| RRC connection setup | 356 |
| RRC connection reconfiguration | 610 |
| Security mode command | 17 |
| RRC connection release | 45 |

To complete a session as shown in FIG. 1, the user equipment may need 23 PDCCHs and 12 downlink transmission. Based on this, the capacity can be shown in Table-2. It can be seen that the capacity is 42, 107 and 178 sessions/s for the relatively worse cases. One session includes the whole procedure of FIG. 1. It should be noted that due to the limit of the PDCCH search space and scheduling algorithm and radio condition, the system may not always reach its maximum capacity. So the actual number of sessions per second may be fewer than the calculated value. In another aspect, a single RX receiver may further reduce the capacity. Besides, center frequency band is also used to transmit system information and probably other messages including RACH messages. According to TR 37.868, if MTCs arrive within seconds, the intensity ranges from tens to hundreds for different deployment scenarios.

TABLE 2
MTC system capacity

| Number of | | | | | | |
|---|---|---|---|---|---|---|
| PRB pairs | | | | | | |
| per message | | | | | | |
| (signaling + | 1.08 MHz (6RBs) | | 3 MHz (15RBs) | | 5 MHz (25RBs) | |
| data) | 1 | 2 | 1 | 2 | 1 | 2 |
| 4 CCEs per | 171 | 85 | 428 | 214 | 714 | 357 |
| PDCCH(1PRB | ses- | ses- | ses- | ses- | ses- | ses- |
| pair) | sions/s | sions/s | sions/s | sions/s | sions/s | sions/s |
| 8 CCEs per | 85 | 42 | 214 | 107 | 357 | 178 |
| PDCCH (2PRB | ses- | ses- | ses- | ses- | ses- | ses- |
| pairs) | sions/s | sions/s | sions/s | sions/s | sions/s | sions/s |

Thus, it is difficult for the 1.08 MHz bandwidth allocated for MTC in the current standard to satisfy the deployment in the future. 3 MHz or 5 MHz bandwidth might be more suitable, where MTC has a higher capacity and a better performance could be achieved through frequency diversity.

The present invention is intended to propose a method of bandwidth configuration enabling asymmetric increasing of the system bandwidth for MTC and the bandwidth of the MTC user equipments. Thus, in the following description of the embodiments, the bandwidth of the MTC user equipment is assumed to be smaller than the system bandwidth for MTC.

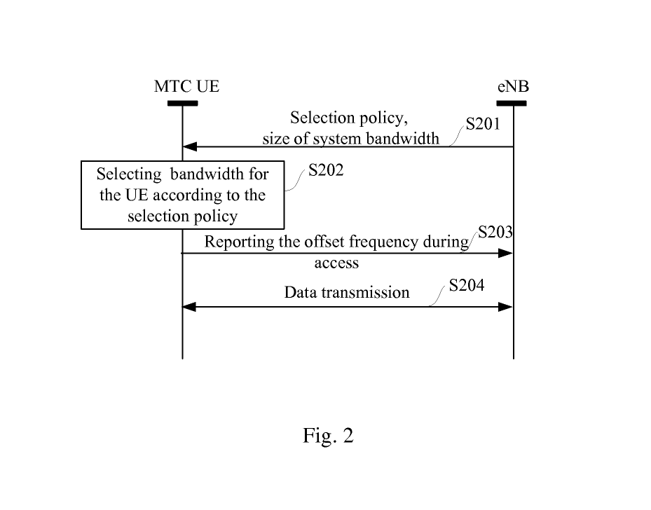

FIG. 2 is a flowchart of a method according to an embodiment of the invention. In this embodiment, the bandwidth of the MTC user equipment is 3M and the system bandwidth for MTC configured at the base station side is 5M.

Specifically, in the step S201, the base station eNB sends a second message and a third message to a Machine Type Communication user equipment. Wherein the second message indicates the size of the system bandwidth for Machine Type Communication, and the third message indicates the predetermined selection policy. Wherein the predetermined selection policy may be any one or any combination of: selecting randomly, selecting according to a probability distribution, and selecting according to a type of the Machine Type Communication user equipment.

Those skilled in the art would appreciate that the step S201 is not essential for the implementation of the invention. As alternative solutions, if the size of the system bandwidth for MTC and/or the predetermined selection policy is/are pre-configured in the MTC user equipment, the step S201 in FIG. 2 could be omitted or only the content, which is not pre-configured in the MTC user equipment, is sent in the step S201.

Those skilled in the art would appreciate that when the selection policy is determined as selecting according to a probability distribution, the base station eNB also needs to send information related to the probability distribution to the MTC user equipment. Alternatively, the information related to the probability distribution could be pre-configured in the MTC user equipment. When the selection policy is determined as selecting according to a type of the MTC user equipment, the base station eNB also needs to send the corresponding relationship between the type of the MTC user equipment and the offset to the MTC user equipment. Similarly, the corresponding relationship could be pre-configured in the MTC user equipment.

Then, in step S202, the MTC user equipment selects bandwidth for the MTC user equipment according to a predetermined selection policy, while ensuring that the selected bandwidth covers center frequency band of the system bandwidth.

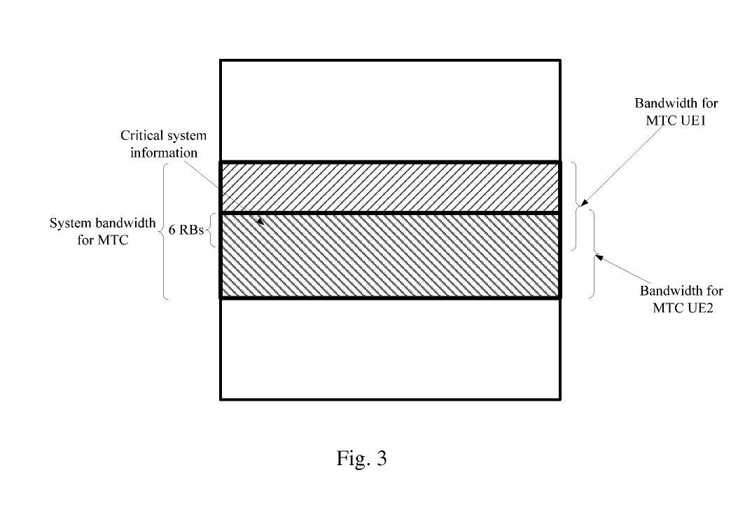

FIG. 3 illustrates the relationship between the bandwidth selected by the MTC user equipments and the system bandwidth according to an embodiment of the invention. Specifically, bandwidth respectively selected by two MTC user equipments MTC UE land MTC UE 2 is shown in FIG. 3. As shown in FIG. 3, the bandwidth selected by two MTC user equipments MTC UE land MTC UE 2 is overlapped in the center frequency band of the system bandwidth for MTC. In this embodiment, the center frequency band of the system bandwidth for MTC includes 6 PRBs, which are used for the transmission of critical system information.

In the embodiment shown in FIG. 3, the offset of the lowest frequency point of the bandwidth selected by the MTC UE 1 relative to that of the system bandwidth is the maximum offset that could be chosen while ensuring the selected bandwidth covers the center frequency band of the system bandwidth. The offset of the lowest frequency point of the bandwidth selected by the MTC UE 2 relative to that of the system bandwidth is zero, which is the minimum offset that could be chosen while ensuring the selected bandwidth covers the center frequency band of the system bandwidth.

In an embodiment of the invention, there are only two selections for the offset of the bandwidth selected by the MTC user equipments relative to the system bandwidth, namely the minimum value and the maximum value. In that case, only one bit of data would be sufficient to indicate the selected bandwidth in the first message, when the MTC user equipment reports to the base station. Thus the amount of data need to be transmitted is reduced, and thus the occupied recourse is reduced.

In another embodiment of the invention, the offset of the bandwidth selected by the MTC user equipment relative to the system bandwidth could be represented using an offset of a highest frequency point of the bandwidth selected by the MTC user equipment relative to that of the system bandwidth or an offset of a center subcarrier of the bandwidth selected by the MTC user equipment relative to that of the system bandwidth.

Those skilled in the art would appreciate that in other embodiments of the invention, the offset of the bandwidth selected by the MTC user equipment relative to the system bandwidth may be any value between the maximum value and the minimum value. In the embodiment where the system bandwidth is 20M, the system bandwidth includes 110 PRBs, and the offset may be 0-42 PRBs.

Returning to FIG. 2, after the step S202, the MTC user equipment reports the offset of the selected bandwidth in step S202 relative to the system bandwidth to the base station eNB while processing access in the step S203. Specifically, the MTC user equipment sends a first message to the base station in the step S203, the first message indicating the offset of the selected bandwidth relative to the system bandwidth. In one embodiment of the invention, the first message further comprises a size of the bandwidth of the MTC user equipment. In another embodiment of the invention, a size of the bandwidth of the MTC user equipment is fixed, and can be pre-configured in the base station.

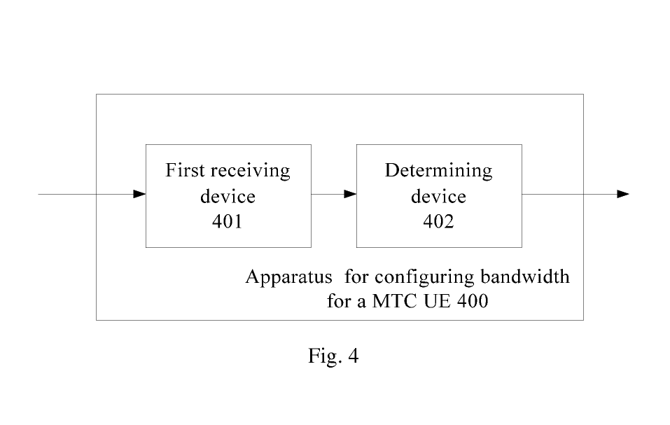

FIG. 4 illustrates a block diagram of an apparatus in a base station, for configuring bandwidth for a MTC user equipment according to an embodiment of the invention. As shown in FIG. 4, the apparatus 400 for configuring bandwidth for a MTC user equipment comprises a first receiving device 401 and a determining device 402.

The first receiving device 401 is configured for receiving a first message from the Machine Type Communication user equipment, the first message indicating an offset of bandwidth selected by the Machine Type Communication user equipment according to a predetermined selection policy relative to the system bandwidth, wherein the selected bandwidth covers center frequency band of the system bandwidth.

The determining device 402 is configured for determining the bandwidth selected by the Machine Type Communication user equipment according to the first message received by the first receiving device 401.

In another embodiment of the invention, the apparatus 400 for configuring bandwidth for a MTC user equipment further comprises a first sending device (not shown), for sending a second message and or a third message to a Machine Type Communication user equipment. Wherein the second message indicates a size of the system bandwidth for Machine Type Communication and the third message indicates the predetermined selection policy.

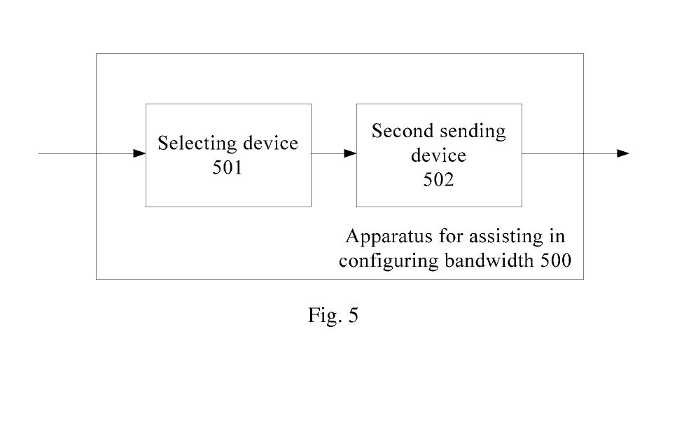

FIG. 5 illustrates a block diagram of an apparatus in a MTC user equipment, for assisting in configuring bandwidth according to an embodiment of the invention. As shown in FIG. 5, the apparatus 500 for assisting in configuring bandwidth comprises a selecting device 501 and a second sending device 502.

The selecting device 501 is configured for selecting bandwidth for the Machine Type Communication user equipment according to a predetermined selection policy, while ensuring that the selected bandwidth covers center frequency band of the system bandwidth.

The second sending device 502 is configured for sending a first message to a base station, the first message indicating an offset of the selected bandwidth relative to the system bandwidth.

In another embodiment of the invention, the apparatus 500 for assisting in configuring bandwidth further comprises a second receiving device (not shown), for receiving a second message and/or a third message from the base station. Wherein, the second message indicates a size of the system bandwidth for Machine Type Communication and the third message indicates the predetermined selection policy.

It shall be noted that the foregoing embodiments are merely exemplary but not to limit the invention, and any technical solutions without departing from the spirit of the invention shall fall into the scope of the invention. Furthermore, any reference numerals in the claims shall not be construed as limiting the claims to which they relate; the term “comprising” shall not preclude other device(s) or step(s) which is(are) not listed in the claims or the description; “a” or “an” preceding a device shall not preclude presence of a plurality of such devices; in an apparatus including a plurality of devices, one or more functions of the plurality of devices can be performed by the same hardware or software module; and the terms “first”, “second”, “third”, etc., are merely intended to represent a name but not to indicate any specific order.

1. A method, in a base station of a Machine Type Communication based communication system, of configuring bandwidth for a Machine Type Communication user equipment, wherein bandwidth of the Machine Type Communication user equipment is smaller than system bandwidth for Machine Type Communication, the method comprising the steps of:
receiving a first message from the Machine Type Communication user equipment, the first message indicating an offset, of bandwidth selected by the Machine Type Communication user equipment according to a predetermined selection policy, relative to the system bandwidth, wherein the selected bandwidth covers center frequency band of the system bandwidth;
determining the bandwidth selected by the Machine Type Communication user equipment according to the first message.

2. The method according to claim 1, wherein before the receiving, the method further comprises:
sending a second message to the Machine Type Communication user equipment, the second message indicating a size of the system bandwidth for Machine Type Communication.

3. The method according to claim 1, wherein before the receiving, the method further comprises:
sending a third message to the Machine Type Communication user equipment, the third message indicating the predetermined selection policy.

4. The method according to claim 1, wherein the predetermined selection policy comprises any one or any combination of:
selecting randomly;
selecting according to a probability distribution;
selecting according to a type of the Machine Type Communication user equipment.

5. The method according to claim 1, wherein the first message further comprises a size of the bandwidth of the Machine Type Communication user equipment, and the offset comprises any one or any combination of:
an offset of a lowest frequency point of the bandwidth selected by the Machine Type Communication user equipment relative to that of the system bandwidth;
an offset of a highest frequency point of the bandwidth selected by the Machine Type Communication user equipment relative to that of the system bandwidth;
an offset of a center subcarrier of the bandwidth selected by the Machine Type Communication user equipment relative to that of the system bandwidth.

6. The method according to claim 1, wherein the offset is a minimum value or a maximum value.

7. A method, in a Machine Type Communication user equipment of a Machine Type Communication based communication system, of assisting in configuring bandwidth, wherein bandwidth of the Machine Type Communication user equipment is smaller than system bandwidth for Machine Type Communication, the method comprising:
selecting bandwidth for the Machine Type Communication user equipment according to a predetermined selection policy, and ensuring that the selected bandwidth covers center frequency band of the system bandwidth;
sending a first message to a base station, the first message indicating an offset of the selected bandwidth relative to the system bandwidth.

8. The method according to claim 7, wherein before the selecting, the method further comprises:
pre-configuring a size of the system bandwidth for Machine Type Communication in the Machine Type Communication user equipment;
receiving a second message from the base station, the second message indicating a size of the system bandwidth for Machine Type Communication.

9. The method according to claim 7, wherein before the selecting, the method further comprises any one of the following steps:
pre-configuring the predetermined selection policy in the Machine Type Communication user equipment.
receiving a third message from the base station, the third message indicating the predetermined selection policy.

10. The method according to claim 7, wherein the predetermined selection policy comprises any one or any combination of:
selecting randomly;
selecting according to a probability distribution;
selecting according to a type of the Machine Type Communication user equipment.

11. The method according to claim 7, wherein the first message further comprises a size of the bandwidth of the Machine Type Communication user equipment, and the offset comprises any one or any combination of:
an offset of a lowest frequency point of the bandwidth selected by the Machine Type Communication user equipment relative to that of the system bandwidth;
an offset of a highest frequency point of the bandwidth selected by the Machine Type Communication user equipment relative to that of the system bandwidth;
an offset of a center subcarrier of the bandwidth selected by the Machine Type Communication user equipment relative to that of the system bandwidth.

12. An apparatus, in a base station of a Machine Type Communication based communication system, for configuring bandwidth for a Machine Type Communication user equipment, wherein bandwidth of the Machine Type Communication user equipment is smaller than system bandwidth for Machine Type Communication, the apparatus comprising:
a first receiving device, for receiving a first message from the Machine Type Communication user equipment, the first message indicating an offset, of bandwidth selected by the Machine Type Communication user equipment according to a predetermined selection policy, relative to the system bandwidth, wherein the selected bandwidth covers center frequency band of the system bandwidth;
a determining device, for determining the bandwidth selected by the Machine Type Communication user equipment according to the first message.

13. The apparatus according to claim 12, wherein the apparatus further comprises:
a first sending device, for sending a second message to the Machine Type Communication user equipment, the second message indicating a size of the system bandwidth for Machine Type Communication, and/or for sending a third message to the Machine Type Communication user equipment, the third message indicating the predetermined selection policy.

14. An apparatus, in a Machine Type Communication user equipment of a Machine Type Communication based communication system, for assisting in configuring bandwidth, wherein bandwidth of the Machine Type Communication user equipment is smaller than system bandwidth for Machine Type Communication, the apparatus comprising:
a selecting device, for selecting bandwidth for the Machine Type Communication user equipment according to a predetermined selection policy, and ensuring that the selected bandwidth covers center frequency band of the system bandwidth;
a second sending device, for sending a first message to a base station, the first message indicating an offset of the selected bandwidth relative to the system bandwidth.

15. The apparatus according to claim 14, wherein the apparatus further comprises:
a second receiving device, for receiving a second message from the base station, the second message indicating a size of the system bandwidth for Machine Type Communication, and/or for receiving a third message from the base station, the third message indicating the predetermined selection policy.
